(19) United States
(12) Patent Application Publication
(10) Pub. No.: US 2017/0083952 A1
(43) Pub. Date: Mar. 23, 2017

(54) SYSTEM AND METHOD OF MARKERLESS INJECTION OF 3D ADS IN AR AND USER INTERACTION

(71) Applicant: Globalive XMG JV Inc., Toronto (CA)

(72) Inventors: Yousuf Chowdhary, Maple (CA); Steven Blumenfeld, Lafayette, CA (US); Kevin Garland, Toronto (CA)

(21) Appl. No.: 15/272,056

(22) Filed: Sep. 21, 2016

Related U.S. Application Data
(60) Provisional application No. 62/221,671, filed on Sep. 22, 2015.

(51) Int. Cl. G06Q 30/02; G06F 3/01; G06F 3/0488; G06F 3/0481; G06F 3/0484; G06T 19/00; G06F 3/16

(52) U.S. Cl. CPC G06Q 30/0277; G06T 19/006; G06F 3/016; G06F 3/167; G06F 3/04815; G06F 3/04845; G06F 3/04842; G06F 3/0488

(57) ABSTRACT

A method is provided for user interaction with a 3D virtual object in augmented reality space. The user has a mobile device. Through the mobile device, a camera feed of a scene is acquired, which includes a flat surface. The mobile device selects a key frame of the flat surface from the feed. The mobile device determines that the flat surface in the key frame meets a predetermined level of feature richness. The mobile device injects a 3D virtual object over at least a part of the key frame. The mobile device detects whether the user is relatively stationary or is in motion through at least one onboard sensor, and provides the user with distinct options for interaction with the 3D virtual object accordingly.

### CROSS-REFERENCE TO RELATED APPLICATION

This application claims the benefit of U.S. Provisional Application No. 62/221,671, filed Sep. 22, 2015. The contents of the priority application are hereby incorporated by reference in its entirety.

### FIELD OF INVENTION

The present invention is related to augmented reality applications in general and more particularly relates to markerless injection of 3D content when encountering a feature rich flat surface in an augmented reality space and user interaction with same.

### BACKGROUND

Advertising is a form of marketing communication used to persuade an audience to generally partake in a transaction. Commercial ads often seek to generate increased consumption of their products or services through “branding”, which involves associating a product name or image with certain qualities in the minds of consumers.

Any place an “identified” sponsor pays to deliver their message through a medium can be considered advertising. Virtually any medium can be used for advertising. Commercial advertising media can include wall paintings, billboards, street furniture components, printed flyers and rack cards, radio, cinema and television adverts, web banners, mobile telephone screens, shopping carts, web popups, skywriting, bus stop benches, human billboards and forehead advertising, magazines, newspapers, town criers, sides of buses, banners attached to or sides of airplanes, in-flight advertisements on seatback tray tables or overhead storage bins, taxicab doors, roof mounts and passenger screens, musical stage shows, subway platforms and trains, elastic bands on disposable diapers, doors of bathroom stalls, stickers on apples in supermarkets, shopping cart handles, the opening section of streaming audio and video, posters, and the backs of event tickets and supermarket receipts amongst many other.

On the spectrum between virtual reality, which creates immersive, computer-generated environments, and the real world, augmented reality is closer to the real world. Augmented reality (AR) refers to the addition of a computer-assisted contextual layer of information over the real world, creating a reality that is enhanced or augmented. The basic idea of augmented reality is to superimpose information in the form of data, graphics, audio and other sensory enhancements (haptic feedback and smell) over a real-world environment as it exists in real time. While augmented reality has been in existence for almost three decades, it has only been in the last few years that the technology has become fast enough and affordable enough for the general population to access. Both video games and cell phones are driving the development of augmented reality. Everyone from tourists, to soldiers, to someone looking for the closest subway stop can now benefit from the ability to place computer-generated information and graphics in their field of vision.

The augmented reality systems use video cameras and other sensor modalities to reconstruct a mixed world that is part real and part virtual. Augmented Reality applications blend virtual images generated by a computer with a real image (for example taken from a camera) viewed by a user.

There are primarily two types of Augmented Reality implementations namely Marker-based and Markerless:
Marker-based implementation utilizes some type of image such as a QR/2D code to produce a result when it is sensed by a reader, typically a camera on a mobile device e.g. a Smartphone
Markerless AR is often more reliant on the sensors in the device being used such as the GPS location, velocity meter, etc. It may also be referred to as Location-based or Position-based AR.

While Markerless Augmented Reality is emerging many markerless AR applications require the use of a built-in GPS to access content tied to a physical location thus superimposing location-based virtual images over the real-world camera feed. Although these capabilities can allow a user to approach a physical location, see digital content in the digital airspace associated with that physical location, and engage with the digital content; such technologies have serious limitations as built-in GPS devices have limited accuracy, cannot work indoors or underground, and may require that a user be connected to a network via WiFi or 4G.

Many AR applications require specialized equipment for example Google Glasses or other head-mounted displays. Although head-mounted displays, or HMDs, have been around for awhile, they are making a comeback as computing devices shrink in size and have better displays and battery life. But this means that the user has to acquire yet another device. This creates a barrier for the creation and presentation of ads to a common user to engage in an Augmented Reality space.

Current advertising media can be costly and require resources that may better be conserved. For example flyers require paper and ink to be printed and require physical resources like vehicles that run on fossil fuels and require humans to be driven for the flyers to be distributed to the target audience. Similarly billboards require physical space for display and are limited to their location for attracting the audience. Additionally the traditional advertising media are rather static and offer little to no user interaction.

Augmented Reality is an emerging technology and provides for an advantageous advertising avenue that is both new and unique with limitless potentials without requiring the physical resources typically associated with the traditional advertising.

### SUMMARY

Broadly speaking, the present invention relates to a markerless Augmented Reality system and method that injects ads into AR space when a feature rich flat surface is detected in the camera feed. This enables a unique and more enjoyable Augmented Reality experience.

A user may first launch an app (either generic or purpose built) that allows a user to interact with the functionality provided by the system. A graphical user interface may be provided for a user to interact with the app features and to personalize for individual needs.

The user interaction may be one of two different and distinct types or a combination thereof. In a first case the user is relatively stationary in relationship to the flat feature rich surface and manipulates the injected virtual object in the AR space using controls. In the second case the user is in motion around a certain flat feature rich surface in the real world, and the AR space shows the different sides of the virtual object as the user moves.

In the preferred embodiment any flat surface with some contrasting features (e.g. contrast of color, or contrast of texture) can be considered a feature rich surface. Thus a smooth black screen may not be considered feature rich as there may not be enough contrast between different points of the surface both in terms of color and texture. Whereas a checkered black and white surface may be considered feature rich as there is enough color contrast between the black and white square. Similarly a brick wall or a concrete surface may be similar in color but will have enough texture on the surface to be considered feature rich.

Some examples of feature rich flat surfaces may include but are not limited to a table, a window, a mirror, a brick patio, a wooden fence, a shingled roof, a framed picture, a French door etc. Furthermore any 3 dimensional object that when shot with a single camera may become a 2 dimensional flat surface (as a single camera cannot perceive depth), thus making a soccer ball a flat feature rich surface.

In one embodiment the user begins by launching an app, which allows a user to interact with the functionality provided by the system. A graphical user interface may be provided for a user to interact with the app features and to personalize for individual needs.

Preferably the app has the capability to connect to the internet and also provides a user an interface which the user may be able to log in or out of the system. The application may be specific for a particular mobile device e.g. an iPhone or a Google Android phone, or a tablet computer etc. or generic e.g. Flash or HTML5 based app that can be used in a browser. In one embodiment the app may be downloaded from a branded Application Store.

Users may use connected devices e.g. a Smartphone, a tablet, or a personal computer to connect with the system e.g. using a browser on a personal computer to access the website or via an app on a mobile device. Devices where invention can be advantageously used may include but not limited to an iPhone, iPad, Smartphones, Android phones, wearable devices, personal computers e.g. laptops, tablet computers, touch-screen computers running any number of different operating systems e.g. MS Windows, Apple iOS, Linux, Ubuntu, etc.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. Instructions for performing different functions may be included in a computer readable storage medium or other computer program product configured for execution by one or more processors.

In one embodiment app acquires a key frame of a given flat surface. The key frame acquisition may be automatic or manual with user assistance. A key frame is a single still image in a sequence of images that occurs at an important point in that sequence e.g. at the start of the sequence, any point when the pose changes etc.

In one embodiment the system determines if the flat surface in the key frame is feature rich by using an algorithm that weights consecutive key frames and determines the best rated feature rich key frame. There are other known methods to assess feature richness.

The app preferably then injects a 3D digital ad in place of the flat feature rich surface e.g. superimposing a 3D digital object e.g. a model wearing a clothing item being advertised. The 3D digital object may contain text, graphics, video, audio and other sensory enhancements to create a realistic 3D augmented realty experience for the user for example when a brick wall is encountered in an AR space.

In some embodiments user interaction can consist of manipulating the injected AR digital ad by moving, expanding, contracting, walking through, linking, and changing certain characteristics.

In some embodiments once a digital ad has been injected into the AR space, a user may be able to interact with such content e.g. walk around the virtual 3D sofa that is being advertised by manipulating the controls to move the 3D content, change color, change design, change size, zoom in, zoom out, share, forward, save, buy etc.

In some embodiments once a digital ad has been injected into the AR space, a user may be able to interact with such content e.g. visit the advertiser's site by virtually touching the ad in the AR space or buying the product/service by virtually touching the ad and optionally paying for it with a digital payment method e.g. automatically paying from a credit card linked to the user's Smartphone, or using a Paypal account of the user and the like.

The user may use any one of the several possible mechanisms to interact with the ads injected in the AR space including but not limited to a touchscreen, keyboard, voice commands, eye movements, gamepad, mouse, joystick, wired game controller, wireless remote game controller or other such mechanism.

A user may have to provide a user name and a password along with other personal or financial information in order to create an account. Personal information for example may include providing address and date of birth, gender, sexual orientation, family status and size, tastes, likes and dislikes and other information related to work, habits, hobbies etc. Financial information may include providing a credit card number, an expiry date and billing address to be used for financial transactions. Creating a user account is a well understood method in prior art. The information gathered via such a user account creation and customization may be used for injecting the appropriate ads that fit the user profile.

The 3D digital ads that are injected may be selected for particular relevance to the user based on aspects of the user's preferences or profile. For example a person with a newborn baby may be shown 3D digital ads that are related to baby products; while a person who is empty-nester may be shown 3D ads for exotic vehicles.

In some embodiments the ads injected to replace the flat feature rich surfaces may be based on past experience and behavior in addition to the user profile and preferences; e.g. previous buying patterns may have an impact on the types of ads that are displayed.

In some embodiments the ads injected to replace the flat feature rich surfaces may be based on the user's social profile, interaction with social media and friends along with places visited and tagged on a social network like Facebook.

In some embodiments the ads injected to replace the flat feature rich surfaces may be based on user behaviour e.g. browsing history captured via cookies. In some embodiments the invention itself may create cookies for storing history specific to the Augmented Reality. Such cookies may maintain a complete or partial record of the state of an object and maintain a record of AR objects (data) that may be used at specific locations amongst other data that may be relevant to an AR experience.

Websites store cookies by automatically storing a text file containing encrypted data on a user's computing device e.g. a Smartphone or a browser the moment the user starts browsing on an online webpage. There are two types of cookies, permanent and temporary cookies. Both have the same capability, which is to create a log/history of the user's online behavior to facilitate future visits to the said website. In Cookie profiling, or web profiling cookies are used to collect and create a profile about a user. Collated data may include browsing habits, demographic data, and statistical information amongst other things and is used for targeted marketing. Social networks may utilizes cookies in order to monitor its users and may use two kinds of cookies; these two are inserted in the browser when a user signs up, while only one of them is inserted when a user lands on the homepage but does not sign up. Additionally, social networks may use different parameters for logged-in users, logged-off members, and non-members.

According to a first aspect of the invention, a method is provided for user interaction with a 3D virtual object in augmented reality space. The user has a mobile device. Through the mobile device, a camera feed of a scene is acquired, which includes a flat surface. The mobile device selects a key frame of the flat surface from the feed. The mobile device determines that the flat surface in the key frame meets a predetermined level of feature richness. The mobile device injects a 3D virtual object over at least a part of the key frame. The mobile device detects whether the user is relatively stationary or is in motion through at least one onboard sensor, and provides the user with distinct options for interaction with the 3D virtual object accordingly.

If the user is detected to be stationary, the user is permitted to do selecting and moving interactions. The moving interactions may include at least one of: resizing, rescaling, relocating, zooming in/out, and reorienting the 3D virtual object. Manipulators may be provided for the user to perform moving interactions on the 3D virtual object. The selecting and moving interactions may be done on the mobile device (e.g. on a touchscreen of the mobile device), or by virtually touching the 3D virtual object in augmented reality space.

If the user is detected to be in motion, the user is permitted to interact with the 3D virtual object by walking around or through the 3D virtual object in augmented reality space. If the user is detected to be in motion, the 3D virtual object may be automatically moved in accordance with the movements of the user in augmented reality space.

The user may further be allowed to change an attribute of the 3D virtual object. For example, the attribute may be an appearance attribute. The attribute may be one of size, color, style, design, features, model, version, pattern, type, or price.

The 3D virtual object may be an item for purchase. For example, the 3D virtual object may, in one embodiment, be a clothing item on a model.

The 3D virtual object may be an advertisement for a product or service. In this case, the interaction may be an interaction to make an inquiry or initiate a transaction, or to request to contact a seller.

The interaction may include receiving feedback on the mobile device. Such feedback may be visual, auditory, audiovisual, haptic or other sensory feedback.

The mobile device may include a wearable component.

### BRIEF DESCRIPTION OF THE FIGURES

FIG. 1 is a flow diagram of a basic outline of the present method.

FIG. 2 is a flow diagram with more specific detail as to user interaction and feedback.

FIG. 3 is a flow diagram with more specific detail as to acquiring a key frame, evaluating feature richness and injecting a 3D virtual object (ad).

FIG. 4 is a flow diagram with more specific detail as to feature richness evaluation.

FIG. 5 is a flow diagram with more specific detail as to pose estimation.

FIG. 6 is a flow diagram with more specific detail as to interaction by moving around a 3D virtual object (ad) in augmented reality space.

### DETAILED DESCRIPTION

Methods and arrangements for injecting ads in markerless augmented reality spaces are disclosed in this application whereby when a flat feature rich surface is encountered, an ad is injected into the AR space to partially or totally replace the flat surface. The application relates to and builds upon a prior invention of the applicants, described in U.S. patent application Ser. No. 15/229,066, filed Aug. 4, 2016, the contents of which are incorporated herein by reference.

Before embodiments are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements. However, it will be understood that, in at least one embodiment, the components comprised in the method and tool are actually implemented in software.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Python, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

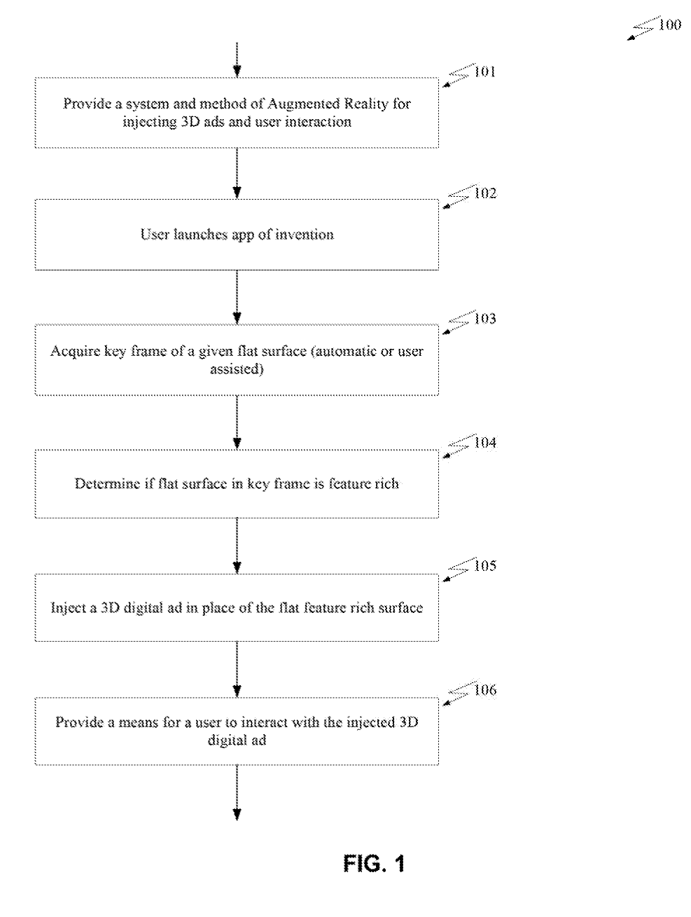

FIG. 1 shows a basic flow of the main method 100. A system and method are provided for injecting 3D ads and user interaction with the injected digital content when encountering a flat feature rich surface in AR space 101. In one embodiment provide a system and method of Augmented Reality for injecting 3D ads and user interaction with the injected digital content when encountering a flat feature rich surface in AR space.

Preferably, any flat surface with some contrasting features (e.g. contrast of color, or contrast of texture) can be considered a feature rich surface. Thus a smooth black screen may not be considered feature rich as there may not be any contrast between different points of the surface both in terms of color and texture. Whereas a checkered black and white surface may be considered feature rich as there is enough color contrast between the black and white square. Similarly a brick wall or a concrete surface may be similar in color but will have enough texture on the surface to be considered feature rich.

Some examples of feature rich flat surfaces may include but are not limited to a table, a window, a mirror, a brick patio, a wooden fence, a shingled roof, a framed picture, a French door etc. Furthermore any 3 dimensional object that when shot with a single camera may become a 2 dimensional flat surface (as a single camera cannot perceive depth), thus making a soccer ball a flat feature rich surface.

Initially, a user launches an app implementing the system and method 102. The app may be either generic or purpose built. It allows the user to interact with the functionality provided by the system. In one embodiment the application (app) may be directly built into the device's operating system (e.g.: IOS, Android, Windows, OSx, Linux, Chrome etc.), which allows a user to interact with the functionality provided by the system. A graphical user interface may be provided for a user to interact with the app features and to personalize for individual needs.

Preferably the app has the capability to connect to the internet and also provides a user an interface which the user may be able to log in or out of the system.

The application may be specific for a particular mobile device e.g. an iPhone or a Google Android phone, or a tablet computer etc. or generic e.g. Flash or HTML5 based app that can be used in a browser. In one embodiment the app may be downloaded from a branded Application Store.

Users may use connected devices e.g. a Smartphone, a tablet, or a personal computer to connect with the system e.g. using a browser on a personal computer to access the website or via an app on a mobile device. Devices where invention can be advantageously used may include but not limited to an iPhone, iPad, Smartphones, Android phones, wearable devices, personal computers e.g. laptops, tablet computers, touch-screen computers running any number of different operating systems e.g. MS Windows, Apple iOS, Linux, Ubuntu, etc.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. Instructions for performing different functions may be included in a computer readable storage medium or other computer program product configured for execution by one or more processors.

A key frame of a given flat surface is acquired (automatic or user assisted) 103. A key frame is a single still image in a sequence of images that occurs at an important point in that sequence e.g. at the start of the sequence, any point when the pose changes etc.

It is determined whether the flat surface in the key frame is feature rich 104. For example, feature richness may be assessed by using an algorithm that weights consecutive key frames and determines the best rated feature rich key frame. Other methods are possible.

Provided the surface is sufficiently feature rich, a 3D digital ad is injected in place of the flat feature rich surface 105. In one embodiment the app injects a 3D digital ad in place of the flat feature rich surface e.g. superimpose a 3D digital object e.g. a model wearing a clothing item being advertised in the AR space using the camera feed as the background. The 3D digital object may also contain text, graphics, video, audio and other sensory enhancements to create a realistic 3D augmented realty experience for the user for example when a flat brick wall is encountered in an AR space.

The user may have to provide a user name and a password along with other personal or financial information in order to create an account. Personal information for example may include providing address and date of birth, gender, sexual orientation, family status and size, tastes, likes and dislikes and other information related to work, habits, hobbies etc. Financial information may include providing a credit card number, an expiry date and billing address to be used for financial transactions. Creating a user account is a well understood method in prior art. The information gathered via such a user account creation and customization may be used for injecting the appropriate ads that fit the user profile.

The user may use any one of several means for interacting with the injected 3D digital ad 106. For example, user interaction can consist of manipulating the injected AR digital ad by moving, expanding, contracting, walking through, linking, and changing certain characteristics.

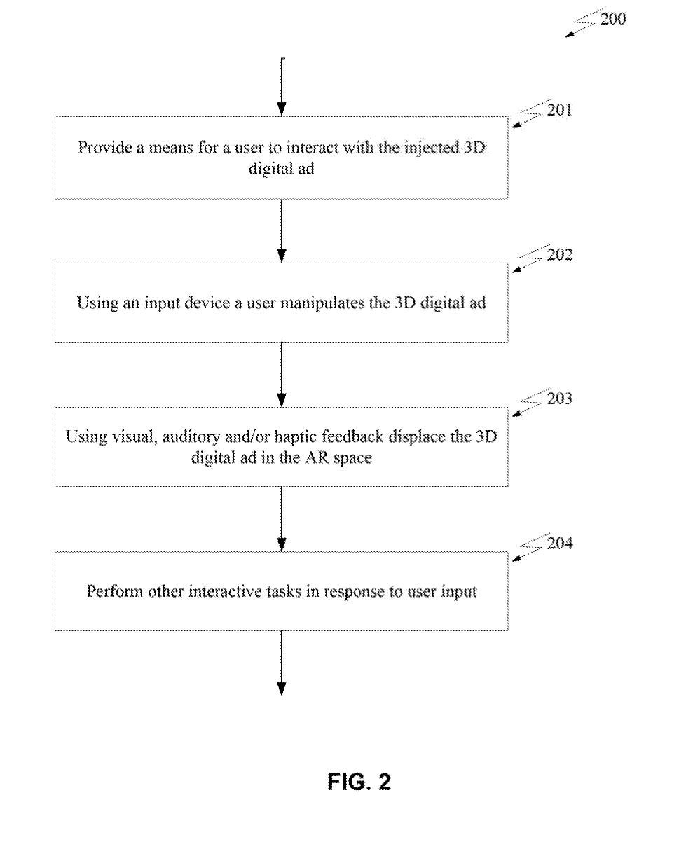

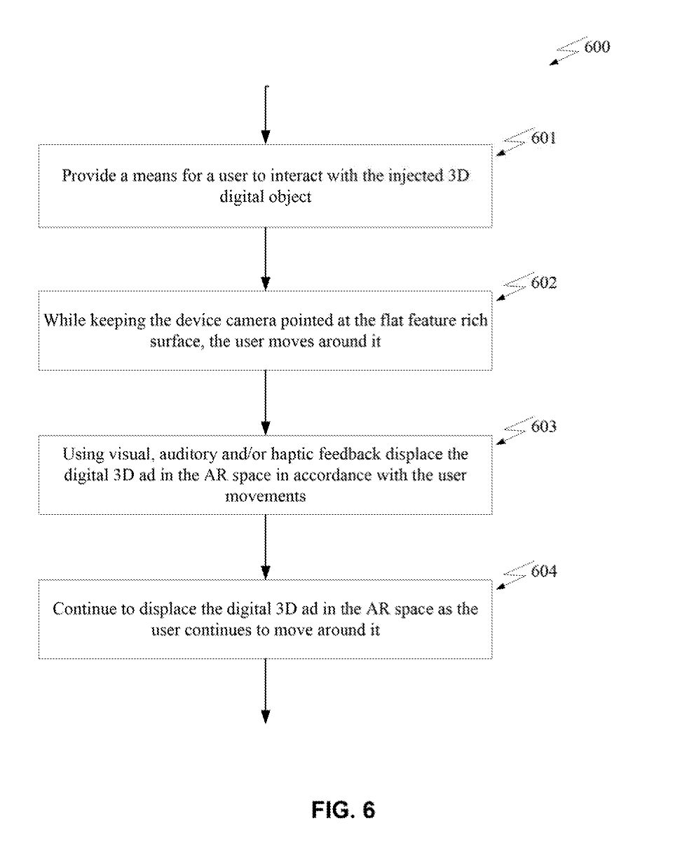

The user interaction may be one of the two different and distinct types or a combination thereof:
1) User is relatively stationary: User is relatively stationary in relationship to the flat feature rich surface and manipulates the injected virtual object in the AR space using controls. Manipulation tasks involve selecting and moving a 3D digital object. Thus the user in this case is generally stationary and uses controls on the screen or keyboard to move, resize, relocate the object in AR space. This scenario is explained in FIG. 2 in more detail.
2) User Moves: For example the user walks around a virtual 3D object. In this case the user actually moves around a certain flat feature rich surface in the real world and the AR space shows the different sides of the virtual object as the user moves. This scenario is explained in FIG. 6 in more detail.

In one embodiment 3D widgets also known as manipulators can be used to put controls on the injected 3D digital ads. Users can then employ these manipulators to re-locate, re-scale or re-orient a 3D digital object (Translate, Scale, Rotate).

FIG. 2 provides a flow chart of user interaction with the injected 3D digital ad according to the preferred embodiment 200.

A means is provided for a user to interact with the injected 3D digital ad 201. For example, a user may use any one of the several possible mechanisms to interact with the ads injected in the AR space including but not limited to a touchscreen, keyboard, voice commands, eye movements, gamepad, mouse, joystick, wired game controller, wireless remote game controller or other such mechanism.

Using an input device a user can manipulate the 3D digital ad 202. In one embodiment using an input device a user manipulates the 3D digital ad; for example a user may employ one or more of the following to interact with the 3D digital ads:
Touchscreen interaction
Graphical menus
Voice commands
Gestural interaction
Virtual tools with specific functions

Using visual, auditory and/or haptic feedback the 3D digital ad may be displaced in the AR space 203. In one embodiment using visual, auditory and/or haptic feedback displace the 3D digital ad in the AR space

Other interactive tasks may be performed in response to user input 204.

In some embodiments user interaction can consist of manipulating the injected AR digital ad by moving, expanding, contracting, walking through, linking, and changing certain characteristics of the injected 3D content.

In some other embodiments user interaction can consist of visiting the advertiser's website by virtually touching the 3D digital ad in the AR space or buy the product/service by virtually touching the ad and optionally paying for it with a digital payment method e.g. automatically paying from a credit card linked to the user's Smartphone, or using a Paypal account of the user and the like.

Examples of interaction with the 3D digital ads may include but are not limited to the following:
1. Re-locate (Translate)
2. Re-scale (Scale)
3. Re-orient (Rotate)
4. Change color (e.g. if the 3D digital ad is a merchandise e.g. a ladies hand bag be able to change its color)
5. Add/replace or change texture (e.g. if the 3D digital ad is for a piece of furniture like a chair be able to change the fabric, change the back from dimpled to flat etc.)
6. Purchase
7. Take a screen shot (e.g. it's an ad for a piece of furniture, place it in AR space, change color, design, size, and reposition in different places in the room; decide on a perfect spot and then take a picture of the digital sofa in the living room and send it to a friend.
8. Inject 3-D ads and interact with them (walk around a virtual 3-D model wearing an advertised clothing item).

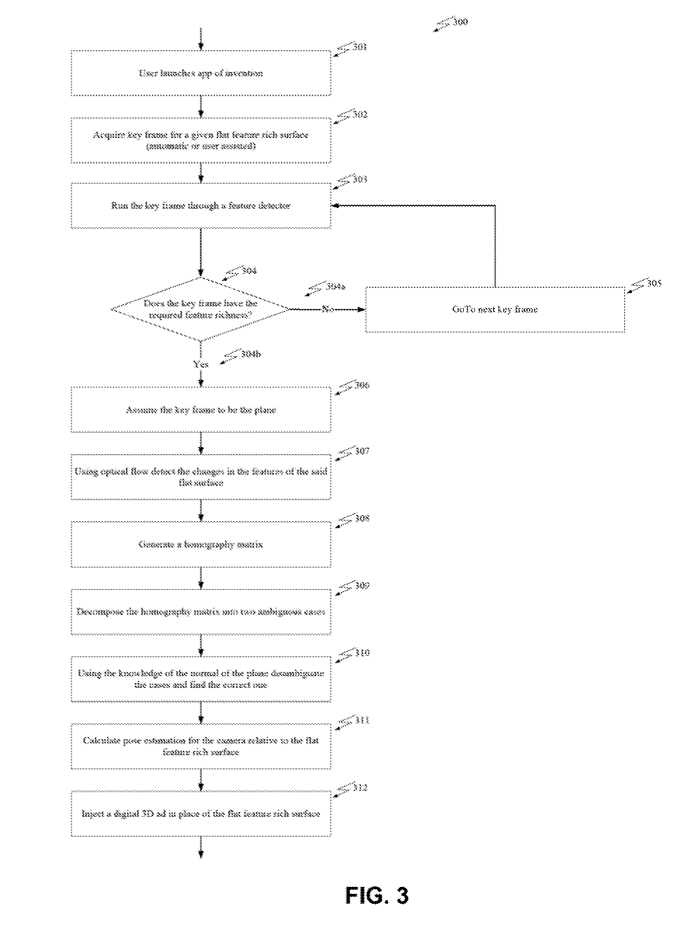

FIG. 3 provides a flow chart of pose estimation with the system according to the preferred embodiment 300.

The user launches the app 301 on a mobile device e.g. a Smartphone or a tablet. The app may be downloaded by a user from an AppStore or may come bundled and pre-loaded with the mobile device.

A key frame is acquired for a given flat feature rich surface (automatic or user assisted) 302. In one embodiment app acquires key frame of a given flat surface using the camera built into the mobile device. In one embodiment the key frame acquisition may be automatic or may be manual with user assistance. A key frame is a single still image in a sequence that occurs at an important point in that sequence.

The key frame is run through a feature detector 303. A feature is defined as an “interesting” part of an image, and features are used as a starting point and main primitives for subsequent algorithms for many computer vision algorithms. Feature detection is a process in computer vision that aims to find visual features within the image with particular desirable properties.

The feature detection algorithm may execute locally on the user's device or on a remote server that is accessible over a network e.g. the internet. In the embodiment where the feature detection is done remotely, an image from the user's device is sent over a connection (wired/wireless/optical etc.) to a remote computing device (e.g. a standalone computer or a server farm) where the feature detection algorithm is executed. The computed results can then be used by the remote server to select the appropriate 3D digital ad content to be sent to the user's device for selection and insertion of appropriate 3D digital ad content.

In some embodiments the system may use a continuous process for example the video stream or a series of stills may be continuously used for acquiring a key frame and then determining if the flat surface in the key frame has the requisite feature richness.

In some embodiments the detected features are some subsection of the key frame and can be points (e.g. Harris corners), connected image regions (e.g. DoG or MSER regions), continuous curves in the image etc. Interesting properties in a key frame can include invariance to noise, perspective transformations and viewpoint changes (camera translation and rotation), scaling (for use in visual feature matching), or properties interesting for specific usages (e.g. visual tracking).

The system determines whether the key frame has the required feature richness 304 as necessitated by a given implementation. If No 304a, the key frame is missing the required features, then the process moves to the next key frame 305. In some embodiments this process may be continuous such that the feature detection process continues till a key frame with specific feature richness is detected.

If Yes 304b, the key frame has the requisite feature richness, then the system assumes the key frame to be the plane 306 comprising the flat surface.

Using optical flow, the system may detect any changes in the features of the said flat surface 307.

The system may generate a homography matrix 308. In the field of computer vision, any two images of the same planar surface in space are related by a homography (assuming a pinhole camera model). Homography is used for image rectification, image registration, or computation of camera motion (rotation and translation) between two images. Two images are related by a homography if and only if:
Both images are viewing the same plane from a different angle
Both images are taken from the same camera but from a different angle
Camera is rotated about its center of projection without any translation

It is important to note that the homography relationship is independent of the scene structure and it does not depend on what the cameras are looking at and the relationship holds regardless of what is seen in the images. A homography is a 3 by 3 matrix M:

$$M = [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ]$$

If the rotation R of a camera and calibration K are known, then homography M can be computed directly. Applying this homography to one image yields the image that would be obtained if the camera was rotated by R.

The homography matrix is decomposed into two ambiguous cases 309. Using the knowledge of the normal of the plane disambiguate the cases and find the correct one 310.

The pose estimation is calculated for the camera relative to the flat feature rich surface 311.

A digital 3D ad is injected in place of the flat feature rich surface 312. Once camera rotation and translation have been extracted from an estimated homography matrix, this information may be used for navigation, or to insert models of 3D objects into an image or video, so that they are rendered with the correct perspective and appear to have been part of the original scene.

The ads that are injected are preferably selected to be particularly relevant to the user. For example a young woman with a newborn baby may be shown ads that are related to baby products; while an older woman may be shown ads for vacations to exotic destinations.

The ads selected may be based on:
past experience and behavior in addition to the user profile and preferences; e.g. previous buying patterns may have an impact on the types of ads that are displayed;
the user's social profile, interaction with social media and friends along with places visited and tagged on a social network like Facebook;
browsing history captured via cookies. In some embodiments the invention itself may create cookies for storing history specific to the Augmented Reality. Such cookies may maintain a complete or partial record of the state of an object and maintain a record of AR objects (data) that may be used at specific locations amongst other data that may be relevant to an AR experience.

In some embodiments the 3D digital ads injected to replace the flat feature rich surfaces may be based on user behaviour e.g. browsing history captured via cookies. Websites store cookies by automatically storing a text file containing encrypted data on a user's computing device e.g. a Smartphone or a browser the moment the user starts browsing on an online webpage. There are two types of cookies, permanent and temporary cookies. Both have the same capability, which is to create a log/history of the user's online behavior to facilitate future visits to the said website. In Cookie profiling, or web profiling cookies are used to collect and create a profile about a user. Collated data may include browsing habits, demographic data, and statistical information amongst other things and is used for targeted marketing. Social networks may utilizes cookies in order to monitor its users and may use two kinds of cookies; these two are inserted in the browser when a user signs up, while only one of them is inserted when a user lands on the homepage but does not sign up. Additionally, social networks may use different parameters for logged-in users, logged-off members, and non-members.

While some exemplary advertising methods and schemes have been given, the invention is not limited to these examples, in fact the invention may use any other kind of method for targeted advertising.

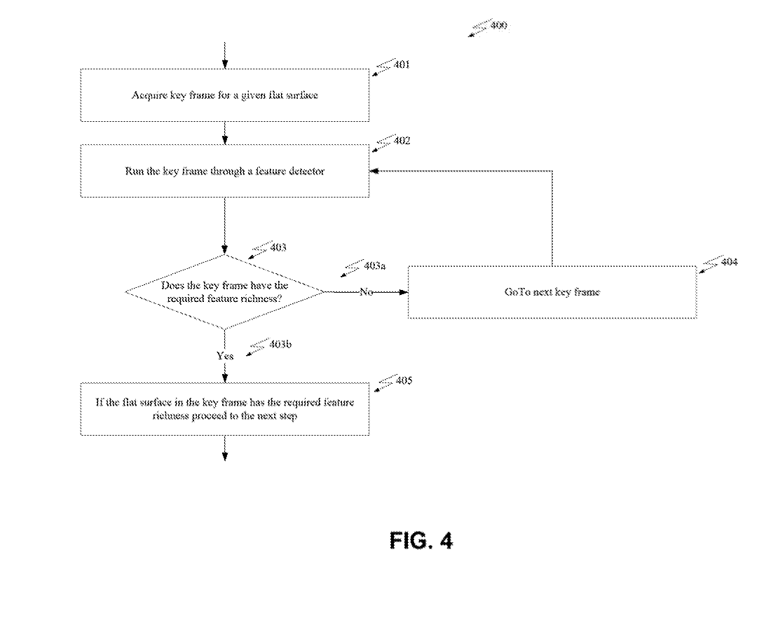

Referring to FIG. 4, a flow chart is provided of the process for determining if a flat surface is feature rich 400. A key frame is acquired for a given flat surface 401. A key frame is a single still image in a sequence of images that occurs at an important point in that particular sequence of images.

The key frame is run through a feature detector 402.

A feature may be defined as an “interesting” part of an image; in the disclosed invention it refers to a flat surface that may have texture or color contrast e.g. a brick wall, or a concrete floor or a checkered board, and the like.

Feature detection is a low-level image processing operation that aims to find visual features within the image with particular desirable properties e.g. a flat feature rich surface. In one embodiment the feature detection refers to methods that aim at computing abstractions of image information and making local decisions at every image point whether there is an image feature of a given type at that point or not.

The system determines whether the key frame has the required feature richness 403. In one embodiment feature detection is performed as the first operation on an image (key frame), and examines every pixel in it and then compares the individual pixels to determine if the compared pixels are sufficiently different e.g. there is sufficient color contrast between the compared pixels for the flat surface to have a contrast.

If the flat surface in the key frame does not have the required feature richness 403a the system proceeds to the next key frame and continues the process.

If the flat surface in the key frame has the required feature richness 403b then the system proceeds to the next step 404 of injecting a 3D digital ad in the AR space where the flat feature rich surface is located.

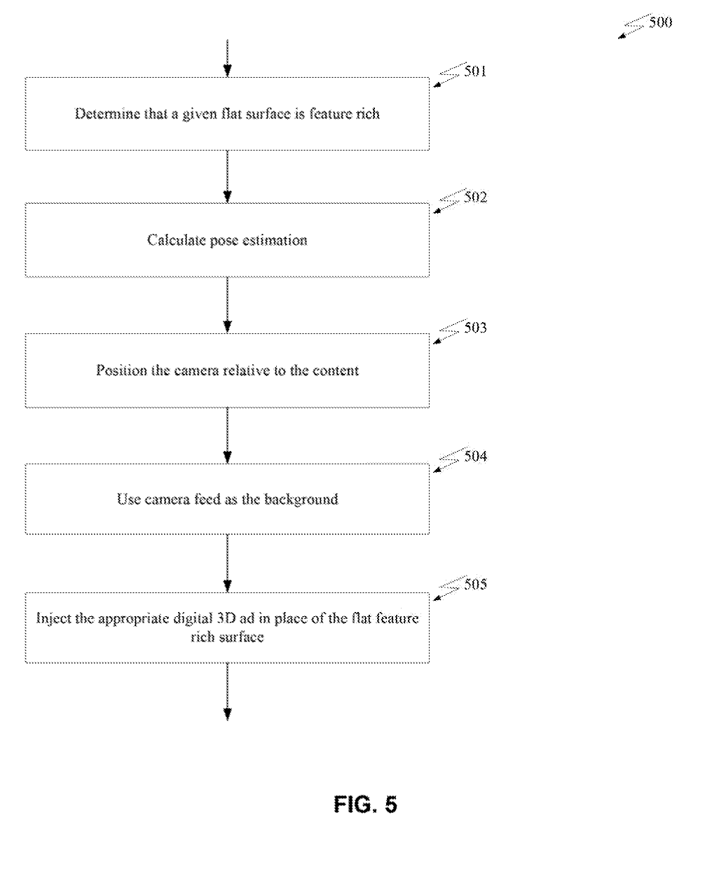

Referring to FIG. 5, a flow chart is provided of the process for the injection of digital content in place of the flat feature rich surface in the Augmented Reality space 500.

The system determine whether a given flat surface is feature rich 501.

Provided it is sufficiently feature rich, the system calculates a pose estimation 502. In computer vision a typical task is to identify specific objects in an image and to determine each object's position and orientation relative to some coordinate system. The combination of position and orientation is referred to as the pose of an object, even though this concept is sometimes used only to describe the orientation. This information can then be used, for example, to allow a computer to manipulate an object or to inject a virtual object into the image in place of the real object in the video steam.

The pose can be described by means of a rotation and translation transformation which brings the object from a reference pose to the observed pose. This rotation transformation can be represented in different ways, e.g., as a rotation matrix or a quaternion.

The specific task of determining the pose of an object in an image (or stereo images, image sequence) is referred to as pose estimation. The pose estimation problem can be solved in different ways depending on the image sensor configuration, and choice of methodology. Three classes of methodologies can be distinguished:
Analytic or geometric methods: Given that the image sensor (camera) is calibrated the mapping from 3D points in the scene and 2D points in the image is known. If also the geometry of the object is known, it means that the projected image of the object on the camera image is a well-known function of the object's pose. Once a set of control points on the object, typically corners or other feature points, has been identified it is then possible to solve the pose transformation from a set of equations which relate the 3D coordinates of the points with their 2D image coordinates. Algorithms that determine the pose of a point cloud with respect to another point cloud are known as point set registration algorithms, if the correspondences between points are not already known.
Genetic algorithm methods: If the pose of an object does not have to be computed in real-time a genetic algorithm may be used. This approach is robust especially when the images are not perfectly calibrated. In this particular case, the pose represent the genetic representation and the error between the projection of the object control points with the image is the fitness function.
Learning-based methods: These methods use artificial learning-based systems which learn the mapping from 2D image features to pose transformation. This means that a sufficiently large set of images of the flat surface (in different poses) must be presented to the system during a learning phase. Once the learning phase is completed, the system is able to present an estimate of the pose of the flat surface and digital ads can be inserted in place of the flat feature rich surface with the same pose.

The preferred embodiment may use the analytic or geometric methods for pose estimation, while other embodiments may use different methods best suited to the particular implementations.

The camera is positioned relative to the content 503. Once camera rotation and translation have been extracted from an estimated homography matrix, this information may be used for navigation, or to insert models of 3D objects into an image or video, so that they are rendered with the correct perspective and appear to have been part of the original scene

The camera feed is used as the background 504, and the appropriate 3D digital ad is injected in place of the flat feature rich surface 505. For example a virtual object that represents a Louis XIV chair may be injected which is being advertised and a discount is being offered for the first 50 buyers.

In some embodiments the 3D virtual object may also be accompanied with superimposed graphics, video, audio and other sensory enhancements like haptic feedback and smell to create a realistic augmented realty experience for the user.

In some embodiments multiple ads may be injected in place of 3D objects that can be broken down into multiple flat feature rich surfaces. For example a 3D object like a box which has 6 flat feature rich surfaces, multiple 3D ads may be injected; e.g. one ad for each of the 6 flat surfaces, such that the surface facing the user may be displaying the visible ads. In some embodiments each surface may be replaced with a different ad where the ads may either be related to each other for example different products from the same vendor or same product from different vendors each with a different price point.

In some embodiments the 3D ads associated with different brands, companies, promotions etc. may be downloaded (either automatically or by user request) from a central server that acts as a repository for ads.

In other embodiments a user may be paid for viewing these ads or may be provided some other free or subsidized items in compensation for watching and interacting with the ads injected in the AR space. In yet other embodiments a user may be required to pay when acquiring and interacting with these ads being injected into the AR space.

In some embodiments once a digital ad has been injected into the AR space, a user may be able to interact with such content e.g. see the virtual 3D sofa that is being advertised from different angles by manipulating the controls to move the 3D content, change color, change design, change size, zoom in, zoom out, share, forward, save, buy etc.

In some embodiments the interaction may also include but is not limited to e.g. be able to visit the advertiser's site by virtually touching the ad in the AR space or buy the product/service being advertised by virtually touching the ad and optionally paying for it with a digital payment method e.g. automatically paying from a credit card linked to the user's Smartphone, or using a Paypal account of the user and the like.

Referring to FIG. 6, a flow chart is provided of the process a user interacting with the 3D digital ad which has been injected in place of the flat feature rich surface in the Augmented Reality space 600.

A means is provided for a user to interact with the injected 3D digital ad 601, e.g. for a user to be able to walk around the flat feature rich surface.

While keeping the device camera pointed at the flat feature rich surface, the user moves around it 602, e.g. from the front to the right side or to the back side of the flat feature rich surface.

Using visual, auditory and/or haptic feedback, the digital 3D ad may be displaced in the AR space in accordance with the user movements 603. In one embodiment using visual, auditory and/or haptic feedback displace the digital 3D ad in the AR space in accordance with the user movements e.g. when the user moves to the right side of the flat feature rich surface, display the right side of the model wearing the advertised clothing item, or display the right side of the kitchen appliance being advertised.

Tactile haptic feedback has become a commonly implemented technology in mobile devices, and in most cases, this takes the form of vibration response to touch. Haptic technology, haptics, or kinesthetic communication, is tactile feedback technology which recreates the sense of touch by applying forces, vibrations, air or motions to the user. This mechanical stimulation can be used to assist in the creation of virtual objects in a computer simulation, to control such virtual objects, and to enhance the remote control of machines and devices.

The system continues to displace the digital 3D ad in the AR space as the user continues to move around it 604. In one embodiment continue to displace the digital 3D ad in the AR space as the user continues to move around it say the user moves from the front of the flat feature rich surface to the right side and then to the back side and then to the left side before reaching the front side again.

It should be noted that the size and scope of the digital content on the screen of the device is not limited to a particular portion of a user's field of vision as the digital content comprising the ad may extend throughout the screen of the mobile device or be sectioned to predetermined viewing dimensions, or dimensions in proportion to the size of the screen.

The digital content displayed on the screen of the mobile device being used for the Augmented Reality experience can be anchored to a particular volume of airspace corresponding to a physical location of the flat feature-rich surface. The mobile device being used for the Augmented Reality experience may display some, or all, of the digital content relative the orientation of the user or screen to the physical location of the flat feature rich surface. That is, if a user is oriented towards the physical location of the flat feature rich surface, the digital content is displayed, but gradually moved and eventually removed as the user moves to become oriented so that the physical location of the flat feature rich surface is not aligned with the user and the screen.

Although the digital content displayed on the screen is not limited to a particular size or position, various embodiments configure the screen of the mobile device being used for the Augmented Reality experience with the capability to render digital content as a variety of different types of media, such as two-dimensional images, three-dimensional images, video, text, executable applications, and customized combinations of the like.

The application is not limited to the cited examples, but the intent is to cover all such areas that are obvious to the ones skilled in the art and may benefit from Augmented Reality to enhance a user experience and provide informative content with which a user can interact.

One embodiment may preferably also provide a framework or an API (Application Programming Interface) that enables a developer to incorporate the functionality of injecting virtual objects/characters/content into an AR space when encountering a flat feature rich surface. Using such a framework or API allows for a more exciting Augmented Reality generation, and eventually allows for more complex and extensive ability to keep a user informed and engaged over a longer duration of time.

It should be understood that although the term app has been used as an example in this disclosure but in essence the term may also imply any other piece of software code where the embodiments are incorporated. The software application can be implemented in a standalone configuration or in combination with other software programs and is not limited to any particular operating system or programming paradigm described here.

Although AR has been exemplified above with reference to advertising, it should be noted that AR is also associated with many industries and applications. For example, AR can be used in movies, cartoons, computer simulations, and video simulations, among others. All of these industries and applications would benefit from aspects of the present invention.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method of user interaction with a 3D virtual object in augmented reality space, the user having a mobile device, the method comprising:
through the mobile device, acquiring a camera feed of a scene, the scene including a flat surface;
the mobile device selecting a key frame of the flat surface from the feed;
the mobile device determining that the flat surface in the key frame meets a predetermined level of feature richness;
the mobile device injecting a 3D virtual object over at least a part of the key frame; and
the mobile device detecting whether the user is relatively stationary or is in motion through at least one onboard sensor, and providing the user with distinct options for interaction with the 3D virtual object accordingly.

2. The method of claim 1, wherein if the user is detected to be stationary, the user is permitted to do selecting and moving interactions.

3. The method of claim 2, wherein the moving interactions include at least one of: resizing, rescaling, relocating, zooming in/out, and reorienting the 3D virtual object.

4. The method of claim 3, wherein manipulators are provided for the user to perform moving interactions on the 3D virtual object.

5. The method of claim 2, wherein the selecting and moving interactions are done on the mobile device.

6. The method of claim 5, wherein the selecting and moving interactions are done on a touchscreen of the mobile device.

7. The method of claim 2, wherein the selecting and moving interactions are done by virtually touching the 3D virtual object in augmented reality space.

8. The method of claim 1, wherein if the user is detected to be in motion, the user is permitted to interact with the 3D virtual object by walking around or through the 3D virtual object in augmented reality space.

9. The method of claim 1, wherein if the user is detected to be in motion, the 3D virtual object is automatically moved in accordance with the movements of the user in augmented reality space.

10. The method of claim 1, further comprising allowing the user to change an attribute of the 3D virtual object.

11. The method of claim 10, wherein the attribute is an appearance attribute.

12. The method of claim 10, wherein the attribute is one of size, color, style, design, features, model, version, pattern, type, or price.

13. The method of claim 1, wherein the 3D virtual object is a clothing item on a model.

14. The method of claim 1, wherein the 3D virtual object is an item for purchase.

15. The method of claim 1, wherein the 3D virtual object is an advertisement for a product or service.

16. The method of claim 15, wherein the interaction is an interaction to make an inquiry or initiate a transaction.

17. The method of claim 15, wherein the interaction is a request to contact a seller.

18. The method of claim 1, wherein the interaction includes receiving feedback on the mobile device.

19. The method of claim 18, wherein the feedback is visual, auditory, audiovisual, haptic or other sensory.

20. The method of claim 1, wherein the mobile device includes a wearable component.
